(19) United States
(12) Patent Application Publication
(10) Pub. No.: US 2015/0116198 A1
(43) Pub. Date: Apr. 30, 2015

(54) DEVICE AND METHOD FOR DISPLAYING MULTIMEDIA CONTENT

(71) Applicants: SONY NETWORK ENTERTAINMENT INTERNATIONAL LLC, Los Angeles, CA (US); SONY CORPORATION, Tokyo (JP)

(72) Inventors: Charles McCoy, Coronado, CA (US); True Xiong, San Diego, CA (US); Leo Pedlow, Ramona, CA (US)

(73) Assignees: SONY NETWORK ENTERTAINMENT INTERNATIONAL LLC, Los Angeles, CA (US); SONY CORPORATION, Tokyo (JP)

(21) Appl. No.: 14/067,493

(22) Filed: Oct. 30, 2013

(51) Int. Cl. G06F 3/00

(52) U.S. Cl. CPC G06F 3/005
USPC 345/156

(57) ABSTRACT

Various aspects of a device and a method for displaying multimedia content are disclosed herein. The method is included in a display device. The method determines a first orientation information of a first viewing position with respect to a display screen associated with the display device. The display screen displays the multimedia content having one or more objects. The method displays a mirror image of the one or more objects on the display screen based on the determined first orientation information.

### FIELD

Various embodiments of the disclosure relate to displaying multimedia content. More specifically, various embodiments of the disclosure relate to displaying multimedia content based on orientation information of a viewing position.

### BACKGROUND

Recent advancements in display technology have made it possible to display different types of multimedia content and associated objects, such as closed captions, on a display screen of a display device. In certain scenarios, a viewer may view the display device from various positions or angles. For instance, a viewer may view the display device through a reflective surface, such as a mirror. In such an instance, the mirror reflection displays the associated objects in a reversed manner (or in other words, a mirror inverted version of the objects). Thus, the viewer may not be able to properly view and/or interpret the mirror reflection of the object associated with the multimedia content.

Further limitations and disadvantages of conventional and traditional approaches will become apparent to one of skill in the art, through comparison of described systems with some aspects of the present disclosure, as set forth in the remainder of the present application and with reference to the drawings.

### SUMMARY

A device and method are provided for displaying multimedia content substantially as shown in, and/or described in connection with, at least one of the figures, as set forth more completely in the claims.

These and other features and advantages of the present disclosure may be appreciated from a review of the following detailed description of the present disclosure, along with the accompanying figures in which like reference numerals refer to like parts throughout.

### BRIEF DESCRIPTION OF THE DRAWINGS

FIG. 1 is a block diagram illustrating a network environment for displaying multimedia content, in accordance with an embodiment of the disclosure.

FIG. 2 is a block diagram illustrating an exemplary display device, in accordance with an embodiment of the disclosure.

FIG. 3 illustrates an exemplary scenario for implementing the disclosed display device and method, in accordance with an embodiment of the disclosure.

FIG. 4 illustrates another exemplary scenario for implementing the disclosed display device and method, in accordance with an embodiment of the disclosure.

FIG. 5 illustrates another exemplary scenario for implementing the disclosed display device and method, in accordance with an embodiment of the disclosure.

FIG. 6 is a flow chart illustrating a method for displaying multimedia content, in accordance with an embodiment of the disclosure.

FIG. 7 is another flow chart illustrating a method for displaying multimedia content, in accordance with an embodiment of the disclosure.

### DETAILED DESCRIPTION

Exemplary aspects of the disclosure may comprise a method for displaying multimedia content in a display device. The method may include determining a first orientation information of a first viewing position with respect to a display screen associated with the display device. The display screen may display the multimedia content including one or more objects. The method may include displaying a mirror image of the one or more objects on the display screen based on the determined first orientation information.

In an embodiment, the first viewing position may correspond to a first viewer viewing a reflection of the display screen.

In an embodiment, the one or more objects may include one or more of an alphanumeric text, a text image, and/or a graphical icon.

In an embodiment, the method may include displaying the mirror image of the one or more objects in a first display portion of the display screen, and the one or more objects in a second display portion of the display screen.

In an embodiment, the first display portion and the second display portion may be non-overlapping.

In an embodiment, the first display portion and the second display portion may be aligned toward opposite edges of the display screen.

In an embodiment, the method may include receiving the one or more objects from a remote server.

In an embodiment, the method may include receiving the mirror image of the one or more objects from the remote server. In such an embodiment, the mirror image of the one or more objects may be generated by the remote server.

In an embodiment, the generation of the mirror image of the one or more objects may be based on at least one user input received from a handheld device communicatively coupled with the display device.

In an embodiment, the method may include determining a second orientation information of a second viewing position with respect to the display screen of the display device. The second viewing position may indicate that a second viewer directly views at least one portion of the display screen of the display device.

In an embodiment, the method may include identifying the first viewer and the second viewer based on one or more biometric parameters associated with the first viewer and the second viewer.

In an embodiment, the method may include modifying the display of the one or more objects when the second viewing position of the second viewer viewing the display screen at an angle relative to a reference axis perpendicular to the display screen.

In an embodiment, the modification of the display of the one or more objects may include one or more of: stretching the display of the one or more objects, expanding the display of the one or more objects, and/or contracting the display of the one or more objects.

In an embodiment, the method may include displaying the modified one or more objects in a second display portion of the display screen.

In an embodiment, the determination of the first orientation information may include receiving a captured image of the first viewer from an image-capturing device, communicatively coupled to the display device.

In an embodiment, the image capturing device may be one or more of a camera in the display device, a surveillance camera, an internet protocol (IP) camera, a motion detector, a motion sensor camera, a remote camera, a rangefinder camera, or a 3D laser camera.

In an embodiment, the method may include displaying the one or more objects based on a first polarization and the mirror image of the one or more objects based on a second polarization. The first polarization may be orthogonal with respect to the second polarization.

In an embodiment, the method may include the determination of a first count of a first plurality of viewers, which correspond to the first orientation information, and a second count of a second plurality of viewers, which correspond to the second orientation information.

In an embodiment, the method may include comparing the first count of the first plurality of viewers and the second count of the second plurality of viewers.

In an embodiment, the method may include displaying the mirror image of the one or more objects in a first display portion and the one or more objects in a second display portion of the display screen, based on the comparison of the first count of the first plurality of viewers and the second count of the second plurality of viewers.

In an embodiment, the first display portion may be aligned toward a top edge of the display screen, and the second display portion may be aligned toward a bottom edge of the display screen.

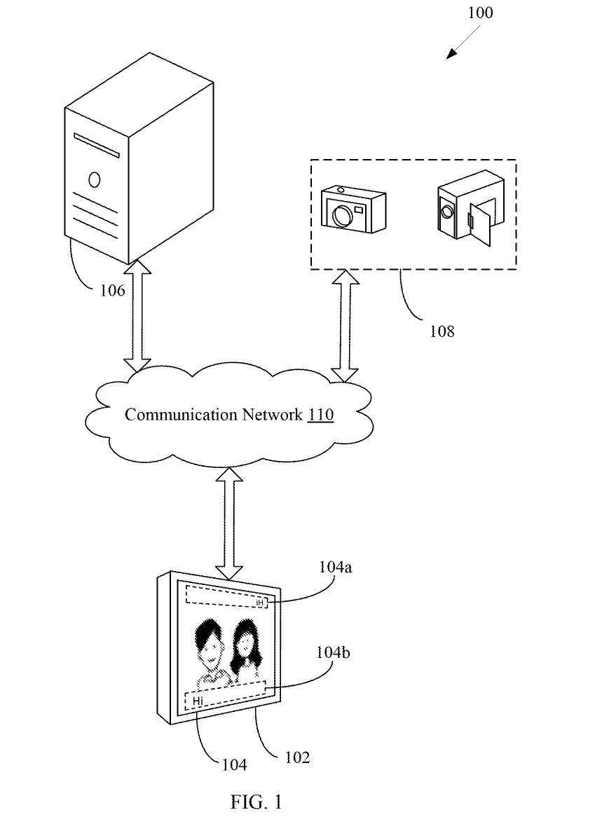

FIG. 1 is a block diagram of a network environment for displaying multimedia content, in accordance with an embodiment of the disclosure. With reference to FIG. 1, there is shown a display device 102. The display device 102 may include a display screen 104, a first display portion 104a, and a second display portion 104b. The display device 102 may be connected to a remote server 106 and/or an image-capturing device 108, via a communication network 110. The display device 102 may be viewed by a first viewer and a second viewer, for example.

The display device 102 may comprise suitable logic, circuitry, interfaces, and/or code that may be operable to receive an electrical signal from the remote server 106 or a television broadcast station (not shown). Based on the received electrical signal, the display device 102 may display a corresponding multimedia content on the display screen 104. In an embodiment, the display device 102 may be operable to communicate with the image-capturing device 108. The display device 102 may be further operable to remotely communicate with a handheld device (not shown), for example, a remote-control apparatus, via a short-range communication network. Such a handheld device may be operable by the first viewer and/or the second viewer. Examples of the display device 102 may include, but are not limited to, a Smart phone, a touch screen device, a laptop, a tablet computer, a television, a video display, and/or a personal digital assistant (PDA) device.

The display screen 104 may comprise suitable logic, circuitry, interfaces, and/or code that may be operable to provide a display of the multimedia content, to the first viewer and/or the second viewer. The display screen 104 may be further operable to display one or more features and/or applications of the display device 102, to the first viewer and/or the second viewer. The display screen 104 may be further operable to receive an input from the first viewer and/or the second viewer, via a touch-sensitive screen. The display screen 104 may be realized through several known technologies such as, but not limited to, Liquid Crystal Display (LCD) display, Light Emitting Diode (LED) display, Organic LED (OLED) display technology, and the like.

The remote server 106 may comprise suitable logic, circuitry, interfaces, and/or code that may be operable to host a first set of applications for the display device 102. Such a first set of applications may include, but are not limited to, webmail, online retail sales, online auctions, wikis, audio-visual conferences, live video sessions, social media, and/or live chat sessions. The remote server 106 may be operable to host a second set of applications to provide closed captions to the display device 102 on demand.

The remote server 106 may be further operable to facilitate live broadcasts, for example, news bulletins, sports events, live entertainment shows, and/or the like, for the display device 102. The remote server 106 may be operable to implement one or more speech recognition algorithms. The one or more speech recognition algorithms may be implemented to provide the one or more objects, for example, closed captions associated with the multimedia content. Such multimedia content may correspond to the first set of applications hosted by the remote server 106, or the live broadcasts streamed by the television broadcast stations in real time, for example stock tickers.

The image-capturing device 108 may comprise suitable logic, circuitry, interfaces, and/or code that may be operable to determine an orientation information of a viewing position (e.g. first orientation information of the first viewing position and second orientation information of the second viewing position), with respect to the display device 102. The image-capturing device 108 may be operable to determine the first orientation information and the second orientation information within a predetermined range with respect to the display device 102. Examples of the image-capturing device 108 may include, but are not limited to, a camera in the display device 102, a surveillance camera, an internet protocol (IP) camera, a motion detector camera, a motion sensor camera, a remote camera, a range-finder camera, and/or a 3D laser camera.

The communication network 110 may include a medium through which the display device 102 may communicate with the remote server 106, the image-capturing device 108, and/or a television broadcast station. Examples of the communication network 110 may include, but are not limited to, the Internet, a Wireless Fidelity (WiFi) network, a Wireless Local Area Network (WLAN), a Local Area Network (LAN), a telephone line (POTS), and/or a Metropolitan Area Network (MAN). Various devices in the network environment 100 may be operable to connect to the communication network 110, in accordance with various wired and wireless communication protocols, such as Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, cellular communication protocols, and/or Bluetooth (BT) communication protocols.

In operation, the display device 102 may be operable to display the multimedia content and the one or more objects associated with the multimedia content. The display device 102 may determine the first orientation information of the first viewing position with respect to the display screen 104 associated with the display device. The first viewing position may indicate, for example, that the first viewer views a reflection of the display screen 104.

Based on the first orientation information, the display device 102 may display a mirror image of the one or more objects in a first display portion 104a of the display screen 104.

In an embodiment, the display device 102 may determine the second orientation information of the second viewing position with respect to the display screen 104 associated with the display device 102. The second viewing position may indicate, for example, that the second viewer directly views the at least one portion of the display screen 104.

Based on the second orientation information, the display device 102 may be operable to display the one or more objects in a second display portion 104b of the display screen 104, such that the second display portion 104b does not overlap with the first display portion 104a of the display screen 104. It is to be noted that the second display portion 104b contains the one or more objects displayed as such without any mirror inversion.

In an embodiment, the display device 102 may be operable to receive the first orientation information of the first viewing position and the second orientation information of the second viewing position from one or more sensors (not shown in FIG. 1) embedded within the display device 102.

In an embodiment, the display device 102 may be operable to receive the first orientation information of the first viewing position and the second orientation information of the second viewing position from the image-capturing device 108. In such an embodiment, the image-capturing device 108 may be a part of the cloud network, and may be communicately coupled with the display device 102.

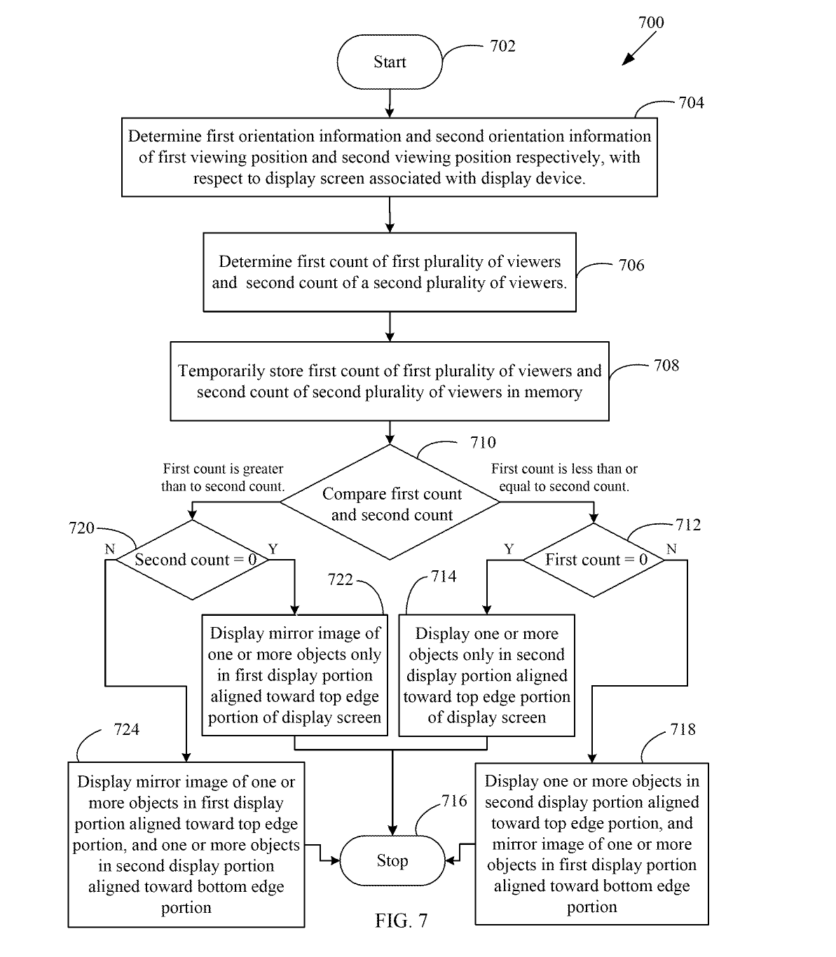

In an embodiment, the first orientation information and the second orientation information may indicate an absence of both the first viewer and the second viewer. In such an embodiment, the display device 102 may be operable to not display the one or more objects and the mirror image of the one or more objects on the display screen 104. Notwithstanding, the disclosure may not be so limited and other embodiments describing the display of the one or more objects and the mirror image of the one or more objects based on the first orientation information and the second orientation information are possible. Such embodiments have been exemplarily illustrated in FIG. 7.

In an embodiment, the display device 102 may be operable to generate the one or more objects associated with the multimedia content. The one or more objects may be generated, based on one or more speech recognition algorithms stored in the local memory of the display device 102.

In an embodiment, the display device 102 may be operable to receive the one or more objects generated by the remote server 106. In such an embodiment, the remote server 106 may be operable to generate the one or more objects, based on one or more speech recognition algorithms stored in the local memory of the remote server 106.

Such one or more speech recognition algorithms may be based on an acoustic modeling algorithm and/or a language modeling algorithm for translation of spoken words within the multimedia content into text. Such a translation of the spoken words within the multimedia content into text may be included in one or more objects, such as closed captions or subtitles. Examples of the one or more speech recognition algorithms may include, but are not limited to, Hidden Markov Models, Dynamic Time Warping (DTW)-based Speech Recognition, and/or Neural Networks.

In an embodiment, the display device 102 may be operable to generate the mirror image of the one or more objects, based on one or more text and/or digital image processing algorithms stored in the local memory.

In an embodiment, the display device 102 may be operable to receive the mirror image of the one or more objects from the remote server 106. In such an embodiment, the remote server 106 may be operable to generate the mirror image of the one or more objects, based on one or more text and/or digital image processing algorithms stored in the local memory of the remote server 106.

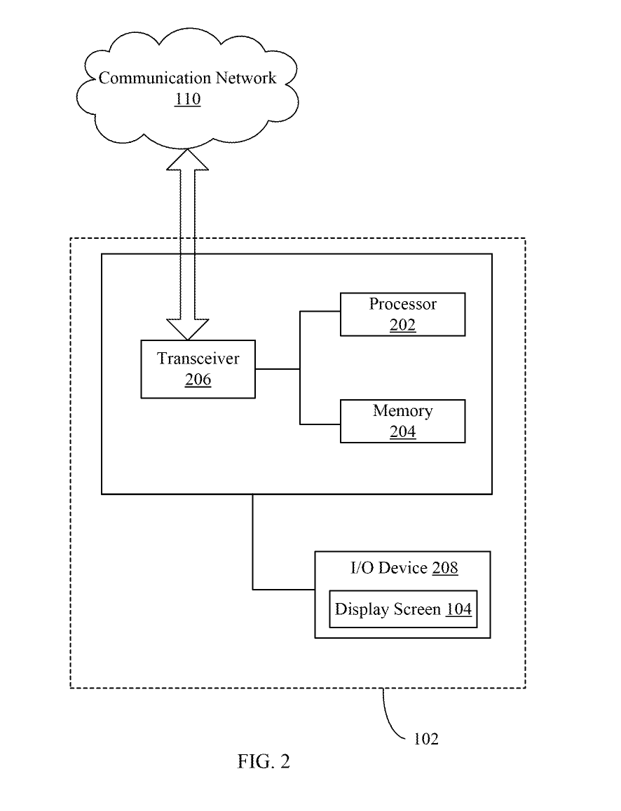

FIG. 2 is a block diagram illustrating a display device, in accordance with an embodiment of the disclosure. FIG. 2 is explained in conjunction with elements from FIG. 1. With reference to FIG. 2, there is shown a display device 102. The display device 102 may comprise one or more processors, such as a processor 202, a memory 204, a transceiver 206, and one or more Input-Output (I/O) devices, such as an I/O device 208.

The processor 202 may be communicatively coupled to the memory 204, and the transceiver 206. Further, the processor 202 may be further communicatively coupled to the I/O device 208.

The processor 202 may comprise suitable logic, circuitry, interfaces, and/or code that may be operable to execute a set of instructions stored in the memory 204. The processor 202 may be implemented based on a number of processor technologies known in the art. Examples of the processor 202 may be an X86-based processor, a Reduced Instruction Set Computing (RISC) processor, an Application-Specific Integrated Circuit (ASIC) processor, a Complex Instruction Set Computing (CISC) processor, and/or any other processor.

In an embodiment, the processor 202 may include one or more sensors operable to receive a touch-based input, a touch-less input and/or a voice-based input. The one or more sensors may include an optical sensor to detect retrieve biometric data of a viewer, for example, two-dimensional or three-dimensional facial expressions, characteristic features of the retina, and characteristic features of the iris. The one or more sensors may include a microphone to detect a voice pattern of the viewer.

The one or more sensors may implement various known biometric algorithms to retrieve one or more biometric parameters, associated with the first viewer and the second viewer. Examples of such biometric algorithms may include, but are not limited to, algorithms for face recognition, voice recognition, retina recognition, thermograms, and/or iris recognition. It will be appreciated by those skilled in the art that any unique characteristic of the user may be accepted as a biometric input within the parameters of the disclosure.

The memory 204 may comprise suitable logic, circuitry, interfaces, and/or code that may be operable to store the received set of instructions. The memory 204 may be implemented based on, but not limited to, a Random Access Memory (RAM), a Read-Only Memory (ROM), a Hard Disk Drive (HDD), a storage server and/or a Secure Digital (SD) card.

The memory 204 may include a multimedia data-store. The multimedia data-store may be operable to store a plurality of multimedia content that the processor 202 may display on the display screen 104. Such a multimedia data-store may be communicatively coupled with a secondary storage device, for example, a hard disk or external storage device, such as a compact disc (CD). Such a communicative coupling may enable the multimedia data-store to buffer multimedia content retrieved from the secondary storage device or the external storage device. The multimedia data-store may be implemented by the use of various multimedia database management systems that are well known to those skilled in the art.

The transceiver 206 may comprise suitable logic, circuitry, interfaces, and/or code that may be operable to communicate with the remote server 106, the image-capturing device 108, and/or the television broadcast station via various communication interfaces. The transceiver 206 may implement known technologies for supporting wired or wireless communication with the communication network 110. The transceiver 206 may include, but is not limited to, an antenna, a radio frequency (RF) transceiver, one or more amplifiers, a tuner, one or more oscillators, a digital signal processor, a coder-decoder (CODEC) chipset, a subscriber identity module (SIM) card, and/or a memory. The transceiver 206 may communicate via wireless communication with networks, such as the Internet, an Intranet and/or a wireless network, such as a cellular telephone network, a wireless local area network (LAN) and/or a metropolitan area network (MAN). The wireless communication may use any of a plurality of communication standards, protocols and technologies including, but not limited to, Global System for Mobile Communications (GSM), Enhanced Data GSM Environment (EDGE), wideband code division multiple access (W-CDMA), code division multiple access (CDMA), time division multiple access (TDMA), Bluetooth, Wireless Fidelity (Wi-Fi) (e.g., IEEE 802.11a, IEEE 802.11b, IEEE 802.11g and/or IEEE 802.11n), voice over Internet Protocol (VoIP), Wi-MAX, a protocol for email, instant messaging, and/or Short Message Service (SMS).

The I/O device 208 may comprise various input and output devices that may be operable to connect to the processor 202. Examples of the input devices may include, but are not limited to, a keyboard, a mouse, a joystick, a touch screen, a microphone, a camera, a motion sensor, a light sensor, and/or a docking station. Examples of the output devices may include, but are not limited to, the display screen 104, and/or a speaker.

In operation, the processor 202 may be operable to display multimedia content and one or more objects associated with the multimedia content, on the display screen 104. The processor 202 may determine the first orientation information of the first viewing position with respect to the display screen 104 associated with the display device 102. The first viewing position may indicate that the first viewer views a reflection of the display screen 104.

Based on the first orientation information, the processor 202 may display a mirror image of the one or more objects in a first display portion 104a of the display screen 104. In an embodiment, the first display portion 104a of the display screen 104 may be aligned toward the horizontal top edge of the display screen 104.

The processor 202 may determine the second orientation information of the second viewing position with respect to the display screen 104 associated with the display device 102. The second viewing position may indicate that the second viewer directly views the at least one portion of the display screen 104.

Based on the second orientation information, the processor 202 may display the one or more objects in the second display portion 104b of the display screen 104, such that the second display portion 104b does not overlap with the first display portion 104a of the display screen 104. In an embodiment, the second display portion 104b of the display screen 104 may be aligned toward the horizontal bottom edge of the display screen 104.

In an embodiment, the processor 202 may modify a display of the one or more objects displayed in the second display portion 104b of the display screen 104. The display of the one or more objects may be modified when the second viewing position indicates that the second viewer views the display screen 104 at a viewing angle relative to a reference axis perpendicular to the display screen 104. In an embodiment, the second viewing position may indicate that the second viewer views the display device 102 directly along the reference axis such that the viewing angle is zero. In an embodiment, the second viewing position may indicate that the second viewer views the display device 102 at a viewing angle that is within a pre-determined range, for example, ±5 degrees about the reference axis.

In an embodiment, the processor 202 may determine a first count of a first plurality of viewers and a second count of a second plurality of viewers. In such an embodiment, the first plurality of viewers, that includes the first viewer, may individually contribute to the determination of the first orientation information of the first viewing position. The first viewing position may indicate that the first plurality of viewers may view a reflection of the display device 102. The second plurality of viewers, that includes the second viewer, may individually contribute to the determination of the second orientation information of the second viewing position. The second viewing position may indicate that the second plurality of viewers may directly view the display screen 104 directly.

In an embodiment, the processor 202 may temporarily store the first count of a first plurality of viewers and the second count of a second plurality of viewers in the memory 204.

In an embodiment, the processor 202 may compare the first count of the first plurality of viewers and the second count of the second plurality of viewers. Based on the comparison, the processor 202 may display the mirror image of the one or more objects in the first display portion 104a and the one or more objects in the second display portion 104b of the display screen 104, respectively.

In instances where the first count of the first plurality of viewers is less than the second count of the second plurality of viewers, the processor 202 may be operable to align the second display portion 104b toward a top edge of the display screen. In such an instance, the processor 202 may be operable to align the first display portion 104a toward a bottom edge of the display screen 104.

In instances where the first count of the first plurality of viewers is greater than the second count of the second plurality of viewers, the processor 202 may be operable to align the second display portion 104b toward a bottom edge of the display screen. In such an instance, the processor 202 may be operable to align the first display portion 104a toward a top edge of the display screen 104.

In an embodiment, the processor 202 may be operable to receive the multimedia content hosted by the remote server 106. In an embodiment, the received multimedia content may be pre-recorded content stored in the remote server 106. In an embodiment, the received multimedia content may be a live broadcast, for example, a live chat show, facilitated by the remote server 106.

In an embodiment, the multimedia content may be retrieved from the multimedia data-store in the memory 204. The processor 202 may be operable to retrieve the multimedia content from the multimedia data-store of the memory 204, based on an instruction transmitted by the first viewer and/or the second viewer, via the handheld device.

In an embodiment, the one or more objects associated with the multimedia content may include one or more of a set of alphanumeric characters, a text embedded in the multimedia content currently displayed on the display screen 104, and/or a set of graphical icons. Examples of the one or more objects may include, but are not limited to, a closed caption, an open caption, a subtitle, and/or a transcribed content.

In an embodiment, the one or more objects, for example, a closed caption, may be embedded in a broadcast signal (such as a television signal), received by the processor 202. The closed captions may be hidden in the line 21 data area, which corresponds to a vertical blanking interval of the television signal. The closed caption may be visible on the display screen 104, when used with a pre-determined decoder. In an embodiment, the pre-determined decoder may be a separate component, such as a set-top decoder, communicately coupled with the processor 202. In an embodiment, the pre-determined decoder may be an in-built component, integrated with the processor 202 of the display device 102. The decoder may allow the second viewer to view the closed caption, in the second display portion 104b aligned toward the horizontal bottom edge of the display screen 104. Such a closed caption may provide the second viewer with written transcription of an audio portion of the multimedia content as it occurs (either verbatim or in edited form). In an embodiment, the closed caption may provide the second viewer with a written transcription of non-speech elements of the multimedia content, for example, a phrase “Applause” for a clapping sound in the multimedia content.

In an embodiment, the processor 202 may be operable to generate the one or more objects, based on one or more speech recognition algorithms stored in the memory 204. In an embodiment, the processor 202 may be operable to receive the one or more objects from the remote server 106.

In an embodiment, the processor 202 may be operable to determine the first orientation information of the first viewing position with respect to the display screen 104.

In an embodiment, the processor 202 may be operable to receive the first orientation information of the first viewing position from the image-capturing device 108, associated with the display device 102.

In an embodiment, the processor 202 may determine the first orientation information of the first viewing position and/or the second orientation information of the second viewing position, based on one or more biometric parameters associated with the first viewer and/or the second viewer, respectivey. The processor 202 may be operable to detect the one or more biometric parameters associated with the first viewer and/or the second viewer. The one or more biometric parameters may include one or more physical characteristics of the first viewer and/or the second viewer. For example, characteristic features (such as eyes, nose, lips and ears) of the face of the first viewer and/or the second viewer or color of skin or hair of the first viewer and/or the second viewer.

In such an embodiment, the processor 202 may be operable to implement various known algorithms on the one or more biometric parameters detected by the one or more sensors. Examples of such algorithms include, but are not limited to, algorithms for face recognition, voice recognition, iris recognition, password matching, and/or fingerprint matching. It would be appreciated by those skilled in the art that any unique characteristic of the viewer may be accepted as an input for identification purposes at least in the parameters of the disclosure.

In an embodiment, upon determination of the first orientation information of the first viewing position, the processor 202 may be operable to generate a mirror image of the one or more objects. In such an embodiment, the processor 202 may be operable to generate the mirror image of the one or more objects, based on the one or more text and/or digital image-processing algorithms stored in the memory 204. In an embodiment, the processor 202 may be operable to generate the mirror image of the one or more objects, based on a local application stored in the memory 204.

In an embodiment, the processor 202 may be operable to receive the mirror image of the one or more objects from the remote server 106, based on the determination of the first orientation information of the first viewing position. In an embodiment, the mirror image of the one or more objects may be generated by the remote server 106, based on one or more instructions, manually transmitted by the first viewer. The one or more instructions may be transmitted by the first viewer via the handheld device, communicatively coupled with the remote server 106.

In an embodiment, the processor 202 may be operable to generate the mirror image of the one or more objects automatically, based on determination of the first orientation information of the first viewing position. In an embodiment, the processor 202 may be operable to generate the mirror image of the one or more objects, based on one or more instructions. The one or more instructions may be manually transmitted by the first viewer via the handheld device communicatively coupled with the display device 102.

In an embodiment, the one or more instructions provided by the first viewer via the handheld device, for example, a remote-control device may be based on a selection of an alphanumeric data or pressing of a pre-specified push button on the handheld device. Such a handheld device may be communicatively coupled with the processor 202 of the display device 102, or the remote server 106.

In an embodiment, the one or more instructions provided by the first viewer via the handheld device, may be based on non-alphanumeric data. Such a non-alphanumeric data may comprise a set of gestures, such as hand gestures, finger gestures, facial gestures, and/or body gestures. The non-alphanumeric data may further comprise speech or audio input, provided by the first viewer.

In such an embodiment, the processor 202 may be operable to interpret the one or more instructions based on the non-alphanumeric data, using an application. In an embodiment, the application may be installed by a manufacturer of the display device 102. In another embodiment, the first viewer may install the application on the display device 102. The application may provide a platform to the first viewer to communicate with the display device 102 via gestures.

In an embodiment, the processor 202 may be operable to modify a display of the one or more objects in the second display portion 104b. The display of the one or more objects may appear to be stretched in a perspective view when the second orientation information of the second viewing position is at a pre-determined angle. Such a pre-determined angle may be relative to a reference axis perpendicular to the display screen 104. Such a stretched perspective view may allow the second viewer to view the displayed one or more objects incorrectly.

In such an embodiment, the processor 202 may be operable to modify the stretched display of the one or more objects in the second display portion 104b. The processor 202 may be operable to perform such a modification, based on one or more text and/or digital image processing algorithms stored in the memory 204. Based on such a modification, the processor 202 may be operable to enable the second viewer to correctly view the one or more objects displayed in the second display portion 104b.

In an embodiment, the modification of the display of the one or more objects may include the one or more objects being stretched, expanded, and/or contracted in one or more different directions.

In an embodiment, the modified display of the one or more objects may be displayed in the second display portion 104b of the display screen 104.

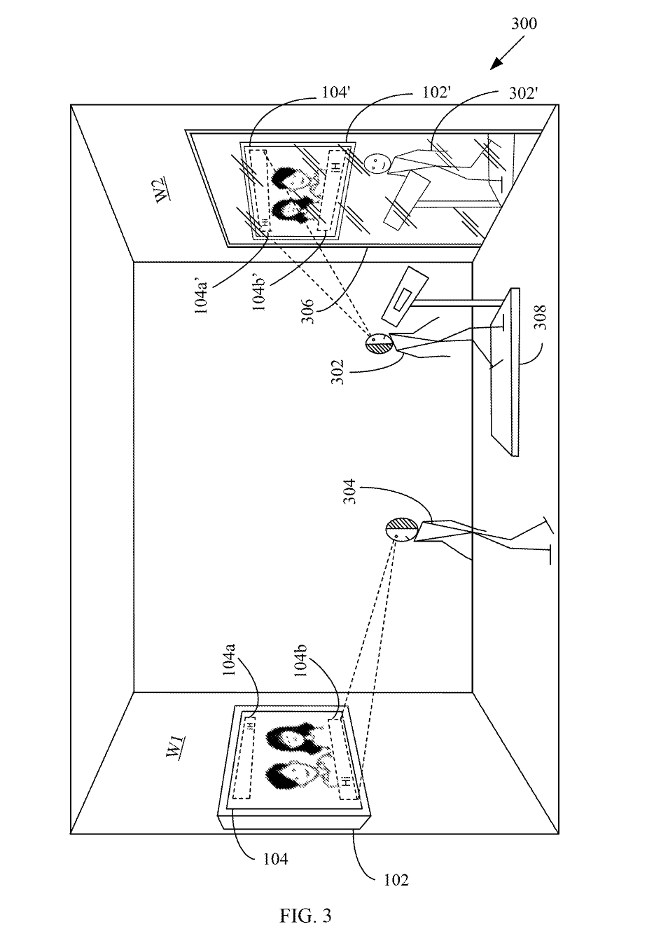

FIG. 3 illustrates an exemplary scenario for implementing the disclosed display device and method, in accordance with an embodiment of the disclosure. FIG. 3 is explained in conjunction with elements from FIG. 1 and FIG. 2. With reference to FIG. 3, there is shown a gymnasium 300 having one or more training equipment, for example, a treadmill 308. The gymnasium 300 may include the display device 102 mounted on a wall W1, a first viewer 302, a second viewer 304, a mirror 306, and a treadmill 308.

The display device 102 may include the display screen 104, operable to display multimedia content, such as a live chat show. The mirror 306 may be mounted on a wall W2, such that the direction of the wall W2 is parallel to a wall W1 on which the display device 102 is mounted. Notwithstanding, the disclosure may not be so limited and the mirror or any other reflecting surface may be placed at a suitable orientation with respect to the viewers.

The one or more sensors in the processor 202 of the display device 102 may be operable to detect the first orientation information of the first viewing position of the first viewer 302 in the gymnasium 300. The first viewer 302, performing a cardiovascular exercise on the treadmill 308 in front of the mirror 306, may be one of a plurality of first viewers. Accordingly, the first viewing position may indicate that the face of the first viewer 302 may be away from the display device 102. Thus, the first viewer may view a mirror image 102′ of the display device 102, and a mirror image 104′ of the display screen 104, via a reflection through the mirror 306. In an embodiment, the first orientation information may be determined by the image-capturing device 108 (not shown in FIG. 3) and communicated to the processor 202.

The one or more sensors in the processor 202 of the display device 102 may be operable to detect the second orientation information of the second viewing position of the second viewer 304 indulged in, for example, Aerobics exercises, in front of the display device 102. The second viewer 304 may be one of a plurality of second viewers in the gymnasium 300. Accordingly, the second viewing position of the second viewer 304 may indicate that the second viewer 304 can directly view the display device 102. In an embodiment, the second orientation information may be determined by the image-capturing device 108 (not shown in FIG. 3) and communicated to the processor 202.

The display device 102 may be operable to display one or more objects, for example, a closed caption ‘Hi’, in the second display portion 104b of the display screen 104. The closed caption may be a transcription of a phrase ‘Hi’ spoken by one of the hosts of the live chat show. The second display portion 104b may be aligned toward the horizontal bottom edge of the display screen 104. Such a second display portion 104b displayed on the display screen 104 may be directly viewed by the second viewer 304.

In an embodiment, based on the determination of the first orientation information of the first viewing position of the first viewer 302, the processor 202 may generate a mirror image 1H′ of the closed caption ‘Hi’. Such a mirror reflected image 1H′ may be displayed in the first display portion 104a of the display screen 104. The first viewer 302 may view the mirror image 104a′ of the first display portion 104a, through a reflection in the mirror 306. It will be understood by those skilled in the art that when a viewer views a mirror image of an object (including a sequence of alphanumeric text and/or graphic icons) through a reflection in a mirror, the viewer may be able to properly read the mirror image of the object as the viewer would read it as an object in the intended orientation.

Thus, the first viewer 302 may be able to read the mirror image of the closed caption displayed in the mirror image 104a′ of the first display portion 104a as intended closed caption ‘Hi’. However, the closed caption displayed in the second display portion 104b may be displayed as a reversed closed caption in a mirror image 104b′ displayed on the mirror image 104′ of the display screen 104. The first viewer 302 may not be able to read the reverse flipped closed caption displayed in the mirror image 104b′ of the second display portion 104b in the mirror 306.

In an embodiment, the first viewer 302 may be the only viewer present in the gymnasium 300. In such an embodiment, the processor 202 may be operable to display the mirror image of the one or more objects only in the first display portion 104a aligned toward a top or bottom edge portion of the display screen 104.

In an embodiment, the second viewer 304 may be the only viewer present in the gymnasium 300. In such an embodiment, the processor 202 may be operable to display the one or more objects only in the second display portion 104b aligned toward a top or bottom edge portion of the display screen 104.

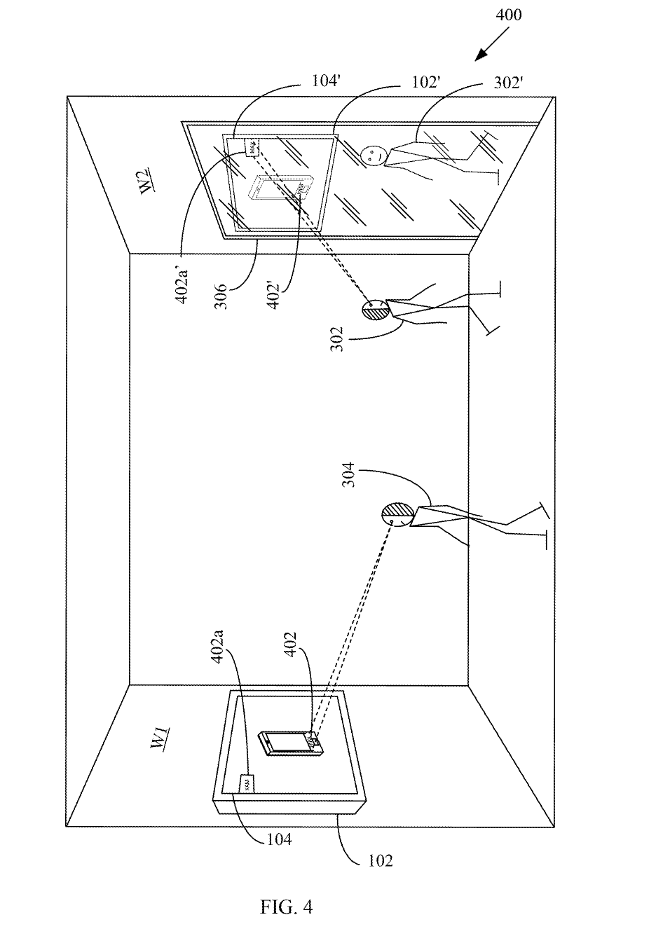

FIG. 4 illustrates another exemplary scenario for implementing the disclosed display device and method, in accordance with an embodiment of the disclosure. FIG. 4 is explained in conjunction with elements from FIG. 1, FIG. 2, and FIG. 3. With reference to FIG. 4, there is shown a retail store 400 including the display device 102, the display screen 104, including all subsequent display portions, viewers, mirror, and mirror images, that have already been described in detail in FIG. 3.

The display device 102, for example, a video display, may be mounted on the wall W1. The display device 102 may be operable to display multimedia content, for example, an image of a smartphone 402 as an advertisement. The multimedia content may include one or more objects, for example, an embedded text ‘MAX’ in the image of the smartphone 402.

In an embodiment, the first viewer 302 may view a mirror image 402′ of the image of a smartphone 402 in the mirror 306. Thus, the embedded text ‘MAX’ displayed in the image of the smartphone 402 at the display screen 104 may be displayed as a reversed embedded text ‘XAM’ in the mirror image 402′ of the image of the smartphone 402. Such a reversed embedded text may or may not be readable or understandable by the first viewer 302.

In such an embodiment, the processor 202 may generate a mirror image of the embedded text, for example, ‘XAM’, and display in a third portion 402a of the display screen 104. Such a generated mirror image of the embedded text in the third portion 402a may be viewed by the first viewer 302 as a mirror image 402a′ of the third portion 402a. Such a mirror image 402a′ may be read by the first viewer 302 as ‘MAX’.

The second viewer 304 may view and read the embedded text ‘MAX’ displayed in multimedia content directly, in the image of the smartphone 104c displayed on the display screen 104.

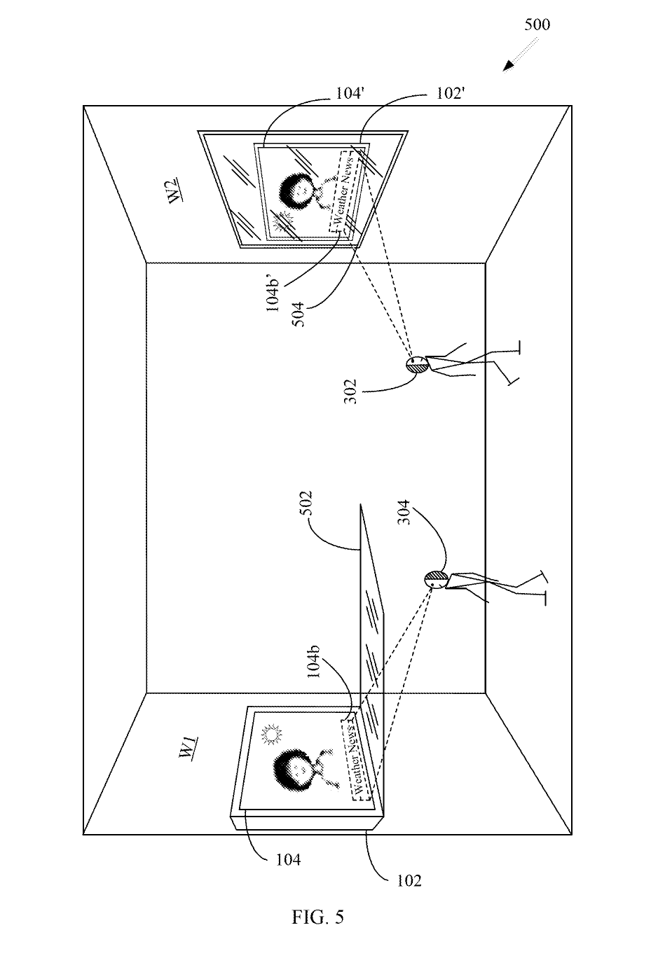

FIG. 5 illustrates another exemplary scenario for implementing the disclosed display device and method, in accordance with an embodiment of the disclosure. FIG. 5 is explained in conjunction with elements from FIG. 1, FIG. 2, and FIG. 3. With reference to FIG. 5, there is shown a hotel corridoor 500 including the display device 102, the display screen 104, a polarized glass 502, and a polarized mirror 504. The display device 102 may be operable to display one or more objects in a pre-determined portion 506 of the display screen 104. All subsequent viewers, and mirror images, have already been described in detail in FIG. 3.

The display device 102, for example, a polarized three-dimensional (3D) video display, may be mounted on the wall W1. The display device 102 may be operable to display multimedia content, for example, a news broadcast. In an embodiment, based on the determination of the first orientation of the first viewing position of the first viewer 302 and the second orientation of the second viewing position of the second viewer 304, the display device 102 may be configured to simultaneously display the one or more objects and the mirror image of the one or more objects in the pre-determined portion 506. For example, a closed caption “Weather News” and a corresponding mirror image of the closed caption based on the spoken words of a news reader presenting the news, may be displayed in the pre-determined portion 506 of the display screen 104.

In such an embodiment, the one or more objects may be displayed in the pre-determined portion 506 based on a first polarization. Similarly, the mirror image of the one or more objects displayed in the pre-determined portion 506 may be based on a second polarization. The first polarization may be orthogonal with respect to the second polarization.

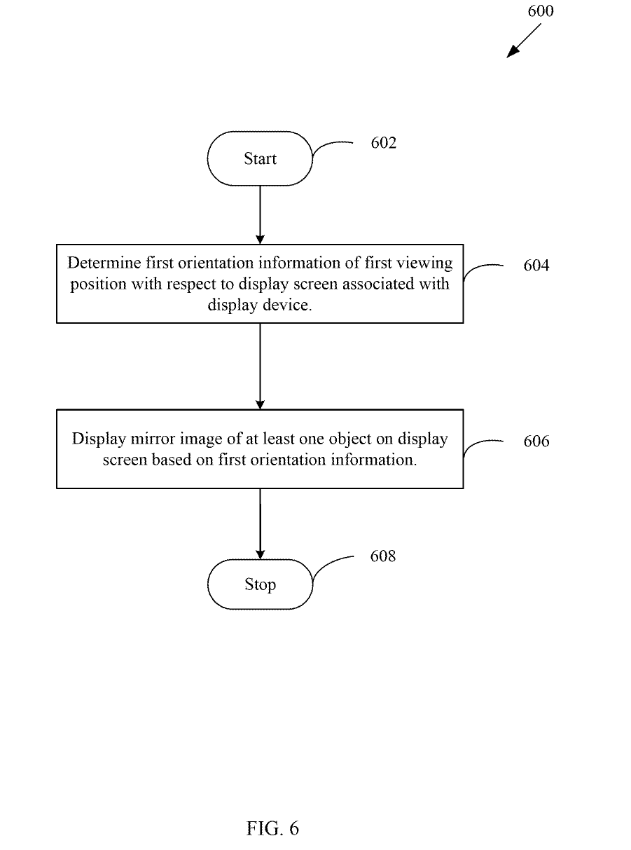

The one or more objects (displayed based on a first polarization) may be viewed only by the second viewer 304 through the polarized glass 502. The mirror image of the one or more objects (displayed based on a second polarization) may be viewed only by the first viewer 302 via a reflection from the polarized mirror 504. Notwithstanding, the disclosure may not be so limited and the polarized glass 502 may be placed either horizontally (as illustrated in FIG. 6) or vertically with respect to the second viewing position or any other suitable angle with respect to the second viewing position without limiting the scope of the disclosure.

In an embodiment, the first viewer 302 may wear first polarized eye-glasses to view the mirror image of the one or more objects. In such an embodiment, physical and structural properties of the first polarized eye-glasses are same as that of the polarized mirror 504. Thus, the first polarized eye-glasses polarize an incident light emerging from the mirror image of the one or more objects, and consequently enable the first viewer 302 to view only the mirror image of the one or more objects, and not the one or more objects. Similarly, the second viewer 304 may wear second polarized eye-glasses to view the one or more objects. In such an embodiment, physical and structural properties of the second polarized eye-glasses are same as that of the polarized glass 502. Thus, the second polarized eye-glasses polarize an incident light emerging from the one or more objects, and consequently enable the second viewer 304 to view only the one or more objects, and not the mirror image of the one or more objects. In such an embodiment, the polarized glass 502 and the polarized mirror 504 may not be used.

In an embodiment, the display device 102 may be a shutter-glass three-dimensional (3D) video display. In such an embodiment, the polarized glass 502 and the polarized mirror 504 may be replaced with shutters that are respectively synchronized to the left and right eye of the shutter-glass 3D video display.

FIG. 6 is a flowchart illustrating a method for displaying multimedia content, in accordance with an embodiment of the disclosure. FIG. 6 is described in conjunction with elements of FIG. 1, FIG. 2, FIG. 3, and FIG. 4. The method 600 may be implemented in the display device 102, communicatively coupled to the remote server 106, and the image-capturing device 108.

The method 600 begins at step 602 and proceeds to step 604.

At step 604, the processor 202 in the display device 102 may be operable to determine first orientation information of the first viewing position with respect to the display screen 104, associated with the display device 102. The display screen 104 may display the multimedia content having one or more objects.

At step 606, the processor 202 may be operable to display a mirror image of the one or more objects on the display screen 104 based on said first orientation information. The first viewing position may correspond to the first viewer's view of the reflection of the display screen 104.

Control then passes to end step 608.

FIG. 7 is another flowchart illustrating a method for displaying multimedia content, in accordance with an embodiment of the disclosure. FIG. 7 is described in conjunction with elements of FIG. 1, FIG. 2, FIG. 3, and FIG. 4. The method 700 may be implemented in the display device 102, communicatively coupled to the remote server 106, and the image-capturing device 108.

The method 700 begins at step 702 and proceeds to step 704.

At step 704, the processor 202 in the display device 102 may be operable to determine first orientation information of the first viewing position with respect to the display screen 104 associated with the display device 102. The processor 202 may be further operable to determine second orientation information of the second viewing position with respect to the display screen 104 of the display device 102. The second viewing position of the second viewer 304 may indicate that the second viewer 304 is facing at least one portion of the display screen 104.

At step 706, the processor 202 may be operable to determine a first count of a first plurality of viewers and a second count of a second plurality of viewers. The first plurality of viewers, that includes the first viewer 302, may individually contribute to the determination of the first orientation information of the first viewing position. The first viewing position may indicate that the first plurality of viewers may view a reflection of the display device 102. The second plurality of viewers, that includes the second viewer 304, may individually contribute to the determination of the second orientation information of the second viewing position. The second viewing position may indicate that the second plurality of viewers may directly view the display screen 104.

At step 708, the processor 202 may be operable to temporarily store the first count of a first plurality of viewers and the second count of a second plurality of viewers in the memory 204.

At step 710, the processor 202 may be operable to compare the first count of the first plurality of viewers and the second count of the second plurality of viewers. Based on the comparison, the processor 202 may be operable to display the one or more objects in the first display portion 104a and the mirror image of the one or more objects in the second display portion 104b of the display screen 104, respectively. Control passes to step 712, in instances where the first count of the first plurality of viewers is less than or equal to the second count of the second plurality of viewers.

At step 712, the processor 202 may be operable to determine whether a value of the first count is zero. Control passes to step 714, in instances where the value of the first count is zero.

At step 714, the processor 202 may be operable to display the one or more objects only in the second display portion 104b, aligned toward a top edge portion of the display screen 104. In such an embodiment, the processor 202 may not display the mirror image of the one or more objects in the first display portion 104a. Control then passes to step 716 where the method ends.

At step 712, control passes to step 718, in instances where the first count of the first plurality of viewers may be greater than or equal to one.

At step 718, the processor 202 may be operable to display the one or more objects in the second display portion 104b, aligned toward a top edge portion of the display screen 104. The processor 202 may be further operable to display the mirror image of the one or more objects in the first display portion 104a, aligned toward a bottom edge portion of the display screen 104. Control then passes to step 716 where the method ends.

Referring back to method step 710, control passes to step 720, in instances where the first count of the first plurality of viewers is greater than the second count of the second plurality of viewers.

At step 720, the processor 202 may be operable to determine whether a value of the second count is zero. Control passes to step 722, in instances where the value of the second count is zero.

At step 722, the processor 202 may be operable to display a mirror image of the one or more objects only in the first display portion 104a, aligned toward a top edge portion of the display screen 104. In such an embodiment, the processor 202 may not display the one or more objects in the second display portion 104b. Control then passes to step 716 where the method ends.

At step 720, control passes to step 724, in instances where the second count of the second plurality of viewers may be greater than or equal to one.

At step 724, the processor 202 may be operable to display mirror image of the one or more objects in the first display portion 104a, aligned toward the top edge portion of the display screen 104. The processor 202 may be further operable to display the one or more objects in the second display portion 104b, aligned toward the bottom edge portion of the display screen 104. Control then passes to step 716 where the method ends.

In accordance with another embodiment of the disclosure, the display device 102 (FIG. 2) for displaying multimedia content is presented. Exemplary aspects of the disclosure may comprise the one or more processors and/or circuits, such as the processor 202 (FIG. 2), in the display device 102. The processor 202 may be operable to determine a first orientation information of a first viewing position with respect to the display screen 104 (FIG. 2), associated with the display device 102. The display screen 104 may display the multimedia content having one or more objects.

The processor 202 may be operable to display a mirror image of the one or more objects (included in a first display portion 104a) on the display screen 104 based on the first viewing position.

Other embodiments of the disclosure may provide a non-transitory computer readable medium and/or storage medium, and/or a non-transitory machine readable medium and/or storage medium. Having applicable mediums stored thereon, a machine code and/or a computer program having at least one code section executable by a machine and/or a computer for displaying multimedia content, may thereby cause the machine and/or computer to perform the steps comprising, in a display device, determining first orientation information of a first viewing position with respect to a display screen, associated with the display device. The display screen may display the multimedia content including one or more objects. The steps further comprise displaying a mirror image of the one or more objects on the display screen based on the first viewing position.

The present disclosure may be realized in hardware, or a combination of hardware and software. The present disclosure may be realized in a centralized fashion, in at least one computer system, or in a distributed fashion, where different elements may be spread across several interconnected computer systems. A computer system or other apparatus adapted for carrying out the methods described herein may be suited. A combination of hardware and software may be a general-purpose computer system with a computer program that, when loaded and executed, may control the computer system such that it carries out the methods described herein. The present disclosure may be realized in hardware that comprises a portion of an integrated circuit that also performs other functions.

The present disclosure may also be embedded in a computer program product, which comprises all the features enabling the implementation of the methods described herein, and which when loaded in a computer system is able to carry out these methods. Computer program, in the present context, means any expression, in any language, code or notation, of a set of instructions intended to cause a system having an information processing capability to perform a particular function either directly, or after either or both of the following: a) conversion to another language, code or notation; b) reproduction in a different material form.

While the present disclosure has been described with reference to certain embodiments, it will be understood by those skilled in the art that various changes may be made and equivalents may be substituted without departing from the scope of the present disclosure. In addition, many modifications may be made to adapt a particular situation or material to the teachings of the present disclosure without departing from its scope. Therefore, it is intended that the present disclosure not be limited to the particular embodiment disclosed, but that the present disclosure will include all embodiments falling within the scope of the appended claims.

What is claimed is:

1. A method for displaying multimedia content, the method comprising:
in a display device:
determining a first orientation information of a first viewing position with respect to a display screen associated with said display device, wherein said display screen displays said multimedia content having one or more objects; and
displaying a mirror image of said one or more objects on said display screen based on said determined first orientation information.

2. The method of claim 1, wherein said first viewing position corresponds to a first viewer viewing a reflection of said display screen.

3. The method of claim 1, wherein said one or more objects comprises one or more of: an alphanumeric text, a text image, and/or a graphical icon.

4. The method of claim 1, further comprising displaying said mirror image of said one or more objects in a first display portion of said display screen, and said one or more objects in a second display portion of said display screen.

5. The method of claim 4, wherein said first display portion and said second display portion are non-overlapping.

6. The method of claim 5, wherein said first display portion and said second display portion are aligned toward opposite edges of said display screen.

7. The method of claim 1, further comprising receiving said one or more objects from a remote server.

8. The method of claim 1, further comprising receiving said mirror image of said one or more objects from said remote server, wherein said mirror image of said one or more objects are generated at said remote server.

9. The method of claim 1, wherein said generating said mirror image of said one or more objects are based on at least one user input received from a handheld device communicatively coupled with said display device.

10. The method of claim 1, further comprising determining a second orientation information of a second viewing position with respect to said display screen of said display device, wherein said second viewing position indicates that a second viewer is facing at least one portion of said display screen of said display device.

11. The method of claim 10, further comprising identifying a first viewer corresponding to said first viewing position and said second viewer based on one or more biometric parameters associated with said first viewer and said second viewer.

12. The method of claim 10, further comprising modifying display of said one or more objects when said second viewing position of said second viewer viewing said display screen at an angle with reference to a reference axis perpendicular to said display screen.

13. The method of claim 12, wherein said modification of said display of said one or more objects comprises one or more of: stretching said display of said one or more objects, expanding said display of said one or more objects, and/or contracting said display of said one or more objects.

14. The method of claim 12, further comprising displaying said modified said one or more objects in a second display portion of said display screen.

15. The method of claim 1, wherein said determining said first orientation information further comprises receiving a captured image of said first viewer from an image capturing device, communicatively coupled to said display device.

16. The method of claim 15, wherein said image capturing device is one or more of: a camera in said display device, a surveillance camera, an internet protocol (IP) camera, a motion detector, a motion sensor camera, a remote camera, a range-finder camera, or a 3D laser camera.

17. The method of claim 1, further comprising displaying said one or more objects based on a first polarization and said mirror image of said one or more objects based on a second polarization.

18. The method of claim 17, wherein said first polarization is orthogonal with respect to said second polarization.

19. The method of claim 1, further comprising
determining a first count of a first plurality of viewers corresponding to said first orientation information, and a second count of a second plurality of viewers corresponding to a second orientation information,
comparing said first count of said first plurality of viewers and said second count of said second plurality of viewers, and
based on said comparing, displaying said mirror image of said one or more objects in a first display portion and said one or more objects in a second display portion, of said display screen.

20. The method of claim 19, wherein said first display portion is aligned toward a top edge portion of said display screen, and said second display portion is aligned toward a bottom edge portion of said display screen.

21. A display device for displaying multimedia content, said display device comprising:
one or more processors being operable to:
determine a first orientation information of a first viewing position with respect to a display screen associated with said display device, wherein said display screen displays said multimedia content having one or more objects; and
display a mirror image of said one or more objects on said display screen based on said determined first orientation information.

22. The display device of claim 21, wherein said first viewing position corresponds to a first viewer viewing a reflection of said display screen.

23. The display device of claim 21, wherein said one or more processors are operable to determine said first orientation information based on capturing an image of said first viewer.

24. A non-transitory computer readable medium, having stored thereon, a computer program having at least one code section executable by a computer, thereby causing the computer to perform the steps comprising:
in a display device,
determining a first orientation information of a first viewing position with respect to a display screen associated with said display device, wherein said display screen displays said multimedia content having one or more objects; and
displaying a mirror image of said one or more objects on said display screen based on said determined first orientation information.

25. The non-transitory computer readable medium of claim 24, wherein said first viewing position corresponds to a first viewer viewing a reflection of said display screen.
